(19) United States
(12) Patent Application Publication
(10) Pub. No.: US 2012/0037092 A1
(43) Pub. Date: Feb. 16, 2012

(54) MULTIPLE PET LEASH

(76) Inventor: Penny A. Sells, Barberton, OH (US)

(21) Appl. No.: 13/108,506

(22) Filed: May 16, 2011

Related U.S. Application Data
(60) Provisional application No. 61/374,013, filed on Aug. 16, 2010.

(51) Int. Cl. A01K 27/00; B23P 11/00

(52) U.S. Cl. 119/795; 29/428

(57) ABSTRACT

A leash assembly for multiple pets can include a swivel member rotatably attached to a base member. The base member can include a shaft and a first ring. The swivel member can include a tube and second and third rings. The shaft of the base member is at least partially located within the tube, and the tube and second and third rings can rotate about the shaft.

### CROSS-REFERENCE TO RELATED APPLICATIONS

This application claims the benefit of U.S. Provisional Application No. 61/374,013, titled WALK ME-2 DOUBLE DOG LEASH, filed Aug. 16, 2010, which is herein incorporated by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present invention relates generally to the field of pet restraints and more specifically to a leash for walking two pets with one hand.

2. Description of Related Art

Leashes have been used since the time man began to keep company with dogs and other pets. Throughout history, from sport to companion and protection, dogs have been leashed so man could control them. The type of collar or harness, and leash worn depended on the job the dog was expected to perform. Handlers using leashes with dogs have been depicted in ancient art dating back to 4400 B.C. Leashes were produced using a wide variety of materials, including: leather, rope, and chain. Coupling collars, attaching two dogs by a chain, were used before releasing dogs for the hunt.

Leash laws generally require owners to keep their dogs on a leash when not restricted to their owners' property. In today's society, a growing number of States have or are developing leash laws, but not all States have State-wide leash laws; most laws affecting dog owners are drafted and approved by local governments. With today's advancements in technology, many pet owners are finding it harder and harder to juggle cell phones, and other hand held devices while spending enjoyable, relaxing time with their pets.

It is known in the art to use leashes for walking multiple pets. However, some of the prior art leashes have several disadvantages for the handler if one of the dogs tends to walk more slowly than the other or the leash is lax.

Therefore, what is needed are apparatus and methods that overcome one or more of the disadvantages in the prior art. Embodiments of the present invention overcome one or more of the disadvantages in the prior art.

### BRIEF SUMMARY OF THE INVENTION

The several embodiments of the leash assembly allow time with pets to be pleasurable, with the convenience of one hand being free, and the security of knowing that dogs will not break free from the leash. The leash assembly is a simple, durable, humane way of walking and training two pets at once with one hand free. According to some embodiments, the leash assembly includes welded or cast metal components with a nylon or leather strapping enabling a unique rotational design to prevent the entanglement of the two pets and maintain a visible separation of the animals.

Many pet owners have two or more large breed dogs that tend to be very strong. According to some embodiments, the leash assembly includes a welded or cast metal main element and a swivel member, which is constructed of heavy duty materials that will not fail when in use with large breed dogs. The unique design of the swivel member gives this invention its strength and durability. Because of the rotational design of the swivel member, the handler is able to guide an individual dog without much effort. The visible separation of leashes allows the handler to easily choose which dog they wish to direct.

According to one embodiment of the invention, a leash assembly for multiple pets can include: a base member including a shaft and a first ring; a swivel member including a tube and second and third rings, the swivel member rotatably connected to the base member, wherein the shaft of the base member is at least partially located within the tube, and wherein the tube and second and third rings rotate about the shaft. The first ring can be positioned at one end of the shaft. The first ring can be fixedly positioned relative to the shaft. The first ring can be fixedly attached to the shaft. The second and third rings can be positioned on opposite sides of the tube. The second and third rings can be fixedly positioned relative to the tube. The second and third rings can be fixedly attached to the tube. The base member can further include a base plate located at or near where the ring and shaft meet or converge, and a bushing positioned between the base plate and the tube of the swivel member. The leash assembly can further include a strap operatively attached to the base member; and first and second leashes operatively attached to the swivel member. The leash assembly can further include: a handle assembly including a padding assembly and a strap, wherein the handle assembly is operatively attached to the first ring of the base member; a first leash operatively attached to the second ring of the swivel member; and a second leash operatively attached to the third ring of the swivel member. The shaft of the base member can extend through the tube, wherein a fastening device can attach to the shaft to rotatably connect the swivel member to the base member, and wherein a bushing can be positioned between the swivel member and the fastening device.

According to another embodiment, a leash assembly for multiple pets can include: a base member including a shaft, a first ring, a base plate, and a bushing, wherein the first ring is fixedly positioned relative to the shaft; a swivel member including a tube and second and third rings, wherein the second and third rings are fixedly positioned relative to the tube, wherein the swivel member is rotatably connected to the base member, and the shaft of the base member is at least partially located within the tube with the bushing positioned between the base plate and the tube, and wherein the tube and second and third rings rotate about the shaft; a handle assembly including a padding assembly and a strap, wherein the handle assembly is operatively attached to the first ring of the base member; a first leash operatively attached to the second ring of the swivel member; and a second leash operatively attached to the third ring of the swivel member.

According to another embodiment, a method can include the steps of: attaching a first ring to a shaft in a fixed relation; attaching second and third rings to a tube in a fixed relation; mounting the tube onto the shaft in a rotational relation; attaching a handle assembly to the first ring; attaching a first leash to the second ring; and attaching a second leash to the third ring. Prior to the step of mounting the tube, the method can further include the steps of positioning a bushing on the shaft. The method can further include the steps of: positioning a bushing on the shaft after mounting the tube onto the shaft; and attaching a fastening device to an end of the shaft maintaining the tube on the shaft in a rotational relation. Prior to attaching a handle assembly, the method can further include the steps of: enclosing a resilient pad within a fabric; and attaching the fabric to a strap to form a handle assembly. The step of enclosing a resilient pad can further include the steps of: placing the resilient pad on the fabric; folding a first edge of the fabric over the resilient pad; folding a second edge of the fabric over the resilient pad; forming a triangle at the top and bottom edges of the fabric; and folding the triangles inwardly substantially encapsulating the resilient pad with the fabric.

The several embodiments of the present invention have several benefits and advantages. The leash assembly with its unique swivel member, is strong, durable, and a simple, humane, tangle free way of walking two dogs at once with one hand free, while directing dogs without much effort from the handler. The leash assembly allows one dog to assist a second dog, which may be blind or otherwise handicap without much effort from the handler. This gives each dog the sense of walking on his or her own leash, but yet with the security of being with another dog. The leash assembly makes walk training easier because of this unique design. The leash assembly makes walking two dogs through multi-story apartment buildings less chaotic. The leash assembly is an effortlessly, strong and secure way to walk two dogs which can be mass produced simply and inexpensively.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 illustrates a perspective view of the leash assembly with a handle and tether attachments demonstrating the rotational design of the swivel member, according to one embodiment;

FIG. 2 illustrates a perspective view of a base member, according to one embodiment;

FIG. 3 illustrates a perspective view of a swivel member, according to one embodiment;

FIG. 4 illustrates a partially assembled view of a leash assembly, according to one embodiment;

FIG. 5 illustrates an assembled view of a leash assembly showing the rotational design of the swivel member, according to one embodiment;

FIG. 6 illustrates a perspective view of the leash assembly with a handle assembly and tether attachments demonstrating the rotational design of the swivel member, according to one embodiment;

FIG. 7 illustrates positioning a resilient pad on a piece of fabric for the padding assembly, according to one embodiment;

FIG. 8 illustrates the position of a resilient pad on a piece of fabric for the padding assembly, according to one embodiment;

FIG. 9 illustrates folding one side of the fabric over the resilient pad for the padding assembly, according to one embodiment;

FIG. 10 illustrates the folding the other side of the fabric over the resilient pad for the padding assembly, according to one embodiment;

FIG. 11 illustrates folding the top and bottom of the fabric for the padding assembly, according to one embodiment;

FIG. 12 illustrates further folding the top and bottom of the fabric for the padding assembly, according to one embodiment;

FIG. 13 illustrates attaching a strap to the padding assembly, according to one embodiment;

FIG. 14 illustrates the handle assembly, according to one embodiment;

FIG. 15 illustrates attaching the handle assembly to the leash assembly, according to one embodiment; and

FIG. 16 illustrates a perspective view of the leash assembly with a handle assembly and tether attachments demonstrating the rotational design of the swivel member, according to one embodiment.

### DETAILED DESCRIPTION OF THE INVENTION

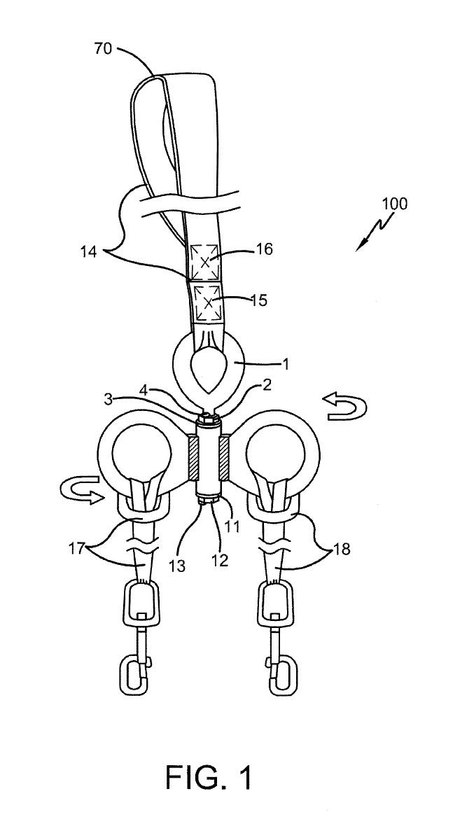

Referring now to the drawings wherein the showings are for purposes of illustrating embodiments of the invention only and not for purposes of limiting the same, and wherein like reference numerals are understood to refer to like components, FIG. 1 shows a leash assembly 100 according to some embodiments. The leash assembly 100 can include a swivel member 10 and a base member 20. The leash assembly 100 can also include a handle or strap 14 and tethers or leashes 17, 18. The swivel member 10 and the base member 20 can be made of a variety of different materials including, but not limited to, plastic, metal, or any other material chosen by a person of ordinary skill in the art.

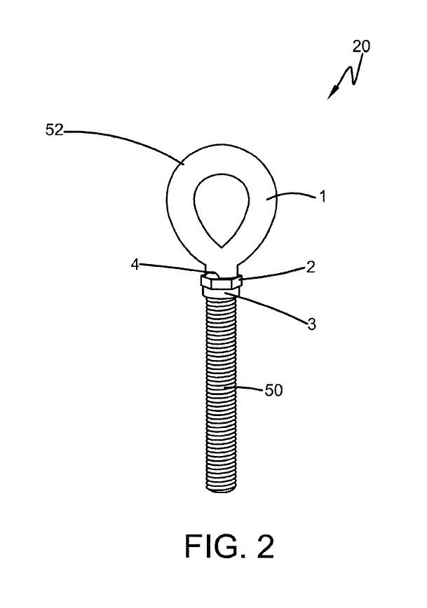

With reference to FIG. 2, the base member 20 can include a rod or shaft 50 and a ring or band 52. The shaft 50 can be substantially cylindrical. The diameter of the shaft 50 can be approximately ¼″, ⅜″, ½″, ⅝″, ¾″, ⅞″, 1″, or any other size chosen by one with ordinary skill in the art. The diameter of the shaft 50 can be between approximately ¼″ and 2″, ¼″ and 1″, ¼″ and ¾″, ¼″ and ½″, or any other range chosen by one with ordinary skill in the art. The ring 52 can have a variety of different shapes including, but not limited to, circular, oval, elliptical, oblong, square, triangular, or any other shape chosen by a person of ordinary skill in the art. The opening in the ring 52 can be approximately ½″, ¾″, 1″, 1¼″, 1½″, 1¾″, 2″, 2½″, 3″, 3½″, 4″, or any other size chosen by one with ordinary skill in the art. The opening in the ring 52 can be between approximately ½″ and 4″, 1″ and 4″, ½″ and 2½″, 1″ and 2″, or any other range chosen by one with ordinary skill in the art. The ring 52 can be fixed in relation to the shaft 50. In one embodiment, the base member 20 is an eye bolt. The base member 20 can also include a base plate 2 and a bushing 3. The base plate 2 can be positioned at or near where the shaft 50 and the ring 52 meet or converge. The base plate 2 can be in a fixed relation to the shaft 50. In some embodiments, the base member 20 can include an eye bolt 1, a base plate or nut 2, and a bushing or washer 3. In one non-limiting example, the base member 20 includes a ⅜″×4″ eye bolt 1, a ⅜″-16 hex nut 2, and a ⅜″ flat washer 3. Many other sizes and dimensions can be used for the base member 20. To assemble the base member 20 according to one embodiment, screw the hex nut 2 onto the eye bolt 1 until it bottoms out; then, tack weld or otherwise secure the top of the hex nut 2 to the eye bolt 1 at or near reference 4; next, place the washer 3 onto eye bolt 1 below hex nut 2.

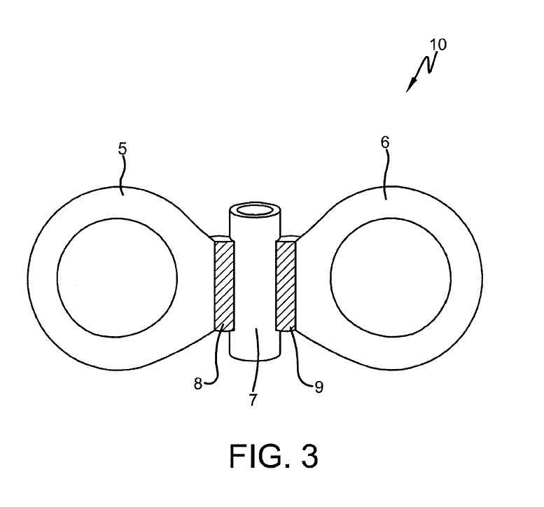

With reference to FIG. 3, the swivel member 10 can include rings 5, 6 and a tube or pipe 7. The swivel member 10 can either be a one-piece device or a multiple piece device. The swivel member 10 can be made out of plastic, metal, cast metal, welding steel, or any other material chosen by a person having ordinary skill in the art. The rings 5, 6 can be positioned on opposite sides of the tube 7 approximately 180° apart. The rings 5, 6 can be fixed in relation to the tube 7. The rings 5, 6 can be attached to the tube 7. The rings 5, 6 can have a variety of different shapes including, but not limited to, circular, oval, elliptical, oblong, square, triangular, or any other shape chosen by a person of ordinary skill in the art. The opening in the rings 5, 6 can be approximately 1½″, 3¼″, 1″, 1¼″, 1½″, 1¾″, 2″, 2½″, 3″, 3½″, 4″, or any other size chosen by one with ordinary skill in the art. The opening in the rings 5, 6 can be between approximately ½″ and 4″, 1″ and 4″, 2½″ and 2½″, 1″ and 2″, or any other range chosen by one with ordinary skill in the art. The tube 7 can have a length of ½″, ¾″, 1″, 1¼″, 1½″, 1 ¾″, 2″, 2½″, 3″, 3½″, 4″, or any other size chosen by one with ordinary skill in the art. The tube 7 can have any length between approximately ½″ and 6″, 1″ and 6″, 1″ and 5″, 1″ and 4″, 1″ and 3″, ½″ and 2½″, 1″ and 2″, 1″ and 1½″, or any other range chosen by one with ordinary skill in the art. In one non-limiting example, the swivel member 10 can include two approximately 1½″ rings 5, 6 that are seam welded at locations 8 and 9 to an approximately 1¼″ long, ⅜″ schedule 80 pipe 7. Many other sizes and dimensions can be used for the swivel member 10. To assemble the swivel member 10 according to one embodiment, seam weld the rings 5 and 6 to the pipe 7 at or near references 8 and 9; after the swivel member 10 adequately cools, turn the swivel member 10 over and seam weld the reverse side at the same references 8 and 9.

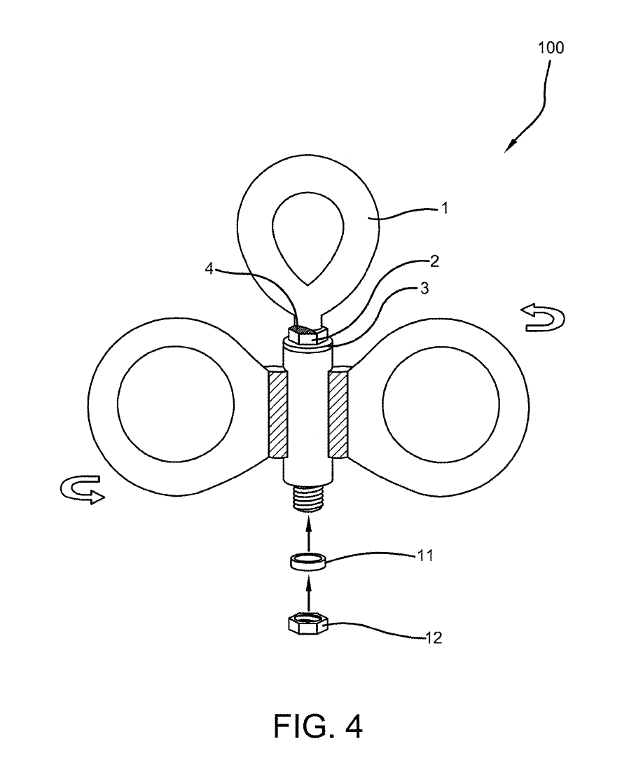

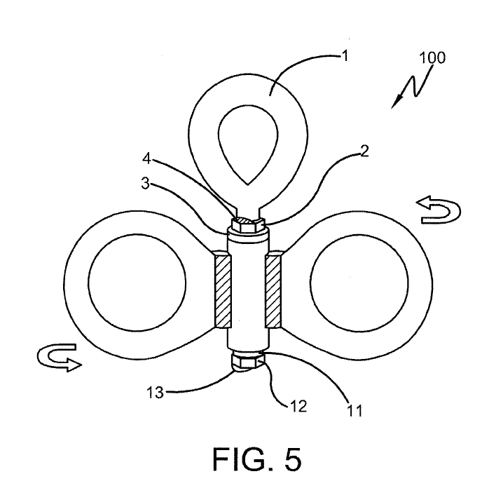

With reference to FIG. 4, the leash assembly 100 is shown partially assembled, according to one embodiment. The tube 7 of the swivel member 10 can be placed over the shaft 50 so that the bushing 3 is positioned between the base plate 2 and the tube 7. A bushing or flat washer 11 can be placed on the shaft 50 next to the swivel member 10. A nut or other fastener 12 can be used to secure the swivel member 10 to the base member 10 with the bushing 11 positioned between the fastener 12 and the swivel member 10. The fastener 12 can also be any type of fastening device or mechanism. Once the base member 20 and the swivel member 10 are assembled, the bushings 3, 11 allow the swivel member 10 to freely rotate about the base member 10. To assemble the leash assembly 10 according to one embodiment, slide the bushing 3 onto the shaft 50 of the base member 20. Then, slide the swivel member 10 onto the shaft 50 of the base member 20. Next, place the bushing 11 on shaft 50 below the swivel member 10. Then, screw or otherwise attach the fastener 12 onto the shaft 50 below the bushing 11 leaving enough clearance so that swivel member 10 can freely rotate on the shaft 50. Next, tack weld or otherwise secure the bottom of hex nut 12 where indicated by reference 13 leaving enough clearance so the swivel member 10 can rotate freely about the base member 20, as shown by the arrows in FIG. 5. An appropriate amount of spray lubrication oil, or any other lubricant chosen by a person of ordinary skill in the art, may be applied to the swivel member 10 to maintain the assembly and allow the assembly to continue rotating freely. The preceding description is just one non-limiting example of assembling the leash assembly 100. Many other devices, apparatus, mechanisms, and methods can be used to secure the swivel member 10 to the base member 20, which are within the scope of this invention.

With reference again to FIG. 1, the leash assembly 100 is shown with the strap 14 and the leashes 17, 18 attached, according to one embodiment. To attach the strap 14 and the leashes 17, 18 to the leash assembly 100 according to one embodiment, feed a nylon or leather strapping 14 through the ring 52 and fold the strapping 14 over. Then, at the reference 15, attach the strapping 14 to itself. Next, fold over the opposite end of nylon or leather strapping 14 contacting the first end at location 16. Then, at reference 16, attach the strapping 14 to itself This creates a handle 14 with an opening for a user's hand. Using any two leashes 17, 18, loop each leash through each ring 5, 6 of the swivel member 10 and pull the leashes 17, 18 tight. Attach the other end of leashes 17 and 18 to two pets. In some embodiments, the leashes can be standard 2′, 4′, or 6′ leashes. The preceding description is just one non-limiting example of attaching the strap 14 and the leashes 17, 18 to the leash assembly 100. Many other devices, apparatus, mechanisms, and methods can be used to attach the strap 14 and the leashes 17, 18 to the leash assembly 100, which are within the scope of this invention.

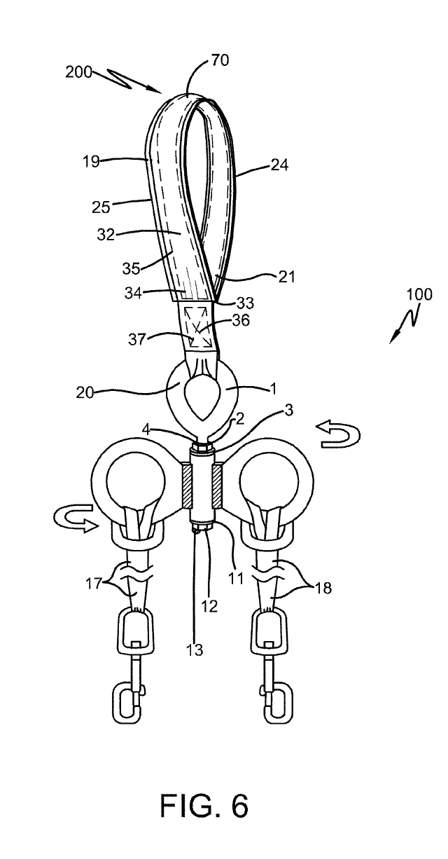

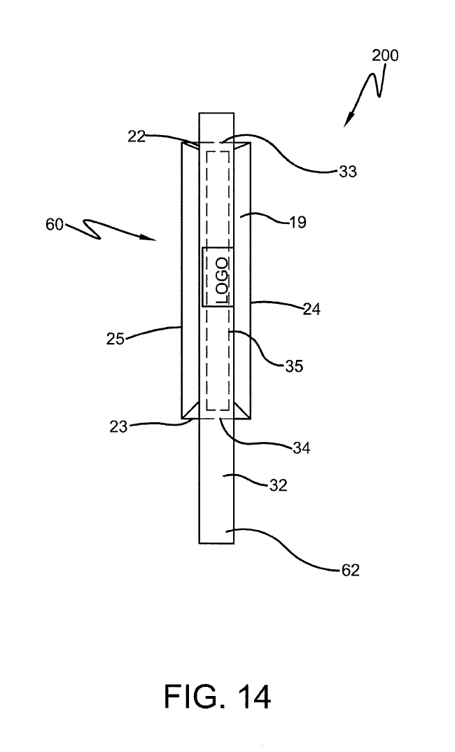

With reference to FIGS. 6, 15, and 16, a leash assembly 100 can include a swivel member 10 and a base member 20. The leash assembly 100 can also include a handle assembly 200 and tethers or leashes 17, 18. The handle assembly 200 can include a padding assembly 60 and a strap 32, as shown in FIG. 14. The strap 32 can be nylon or leather strapping, or any other material chosen by a person of ordinary skill in the art. The padding assembly 60 can include a fabric 19 and a resilient pad 21. The fabric 19 can be a rip stop nylon fabric or any other fabric chosen by a person of ordinary skill in the art. The resilient pad 21 can be foam padding or any other type of padding chosen by a person of ordinary skill in the art.

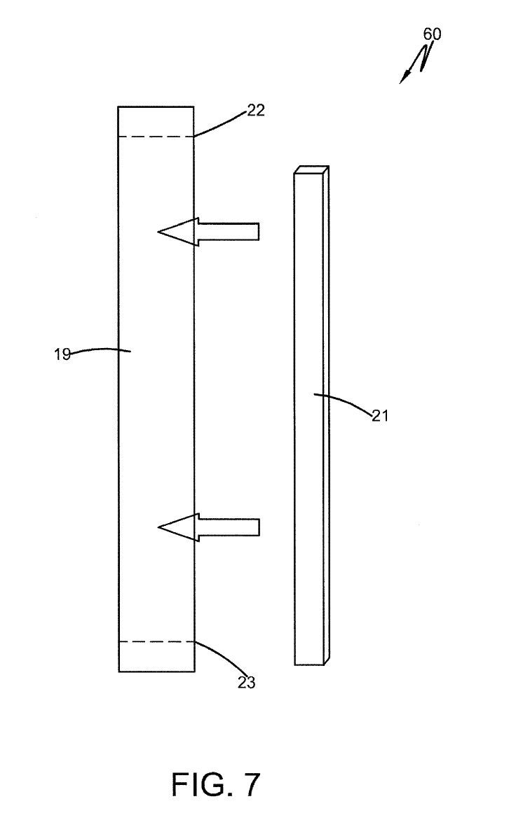

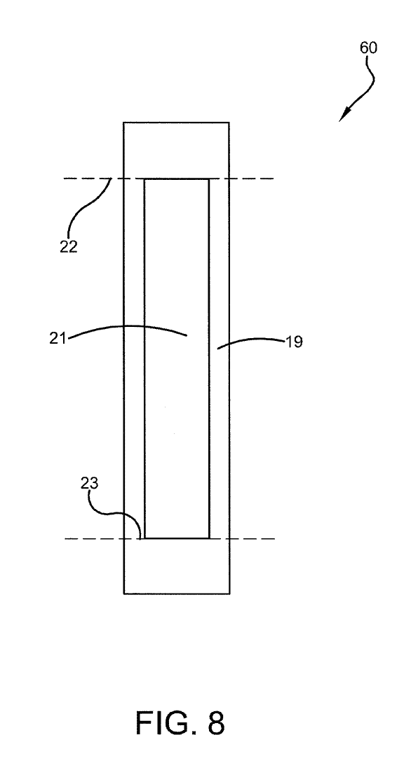

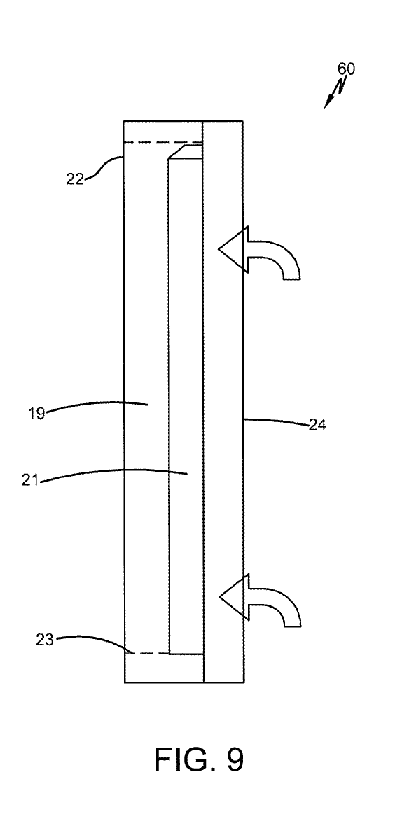

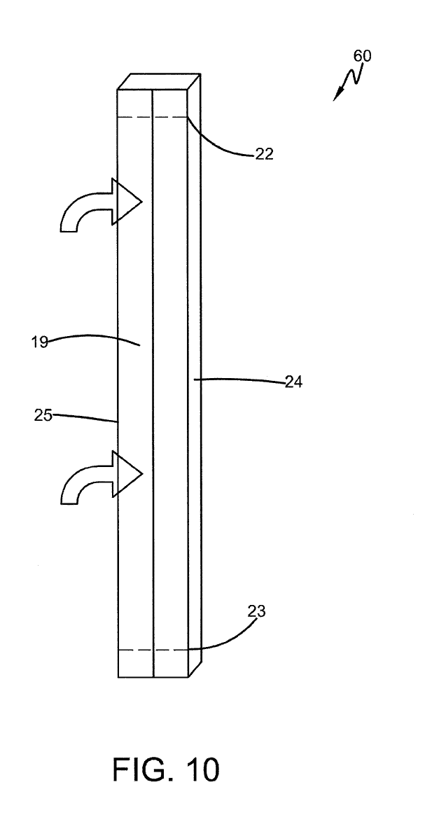

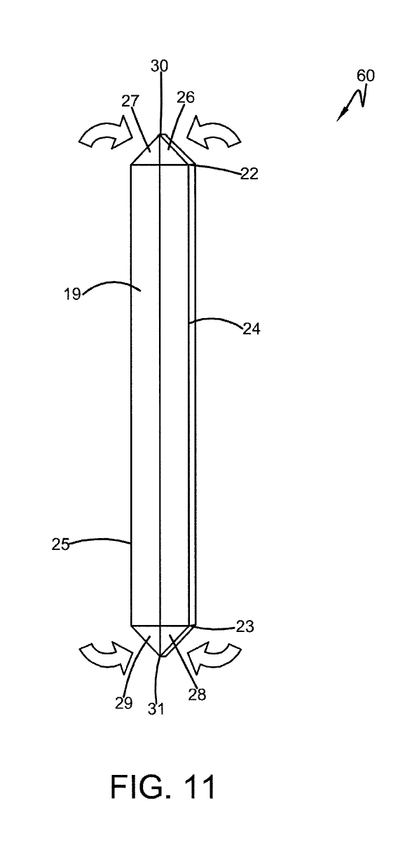

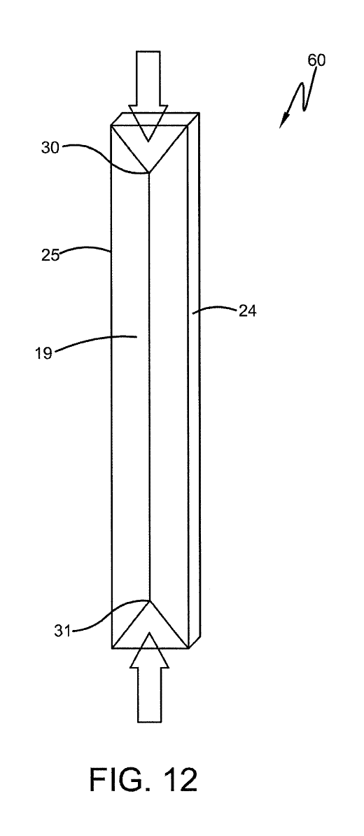

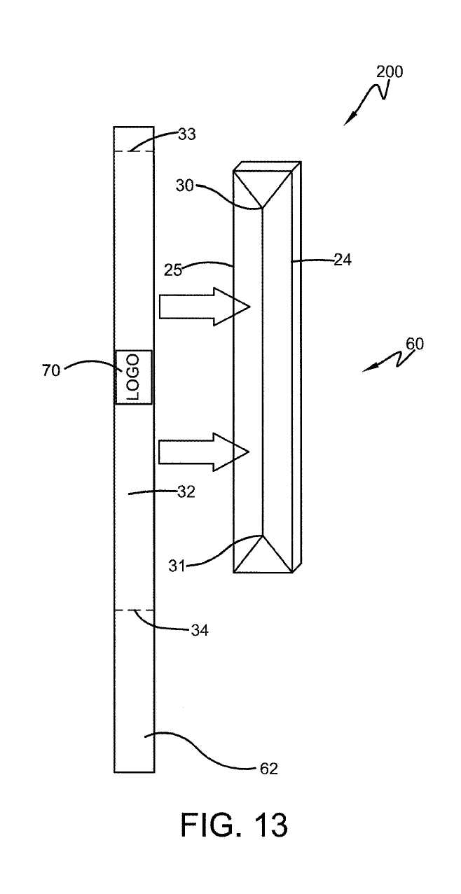

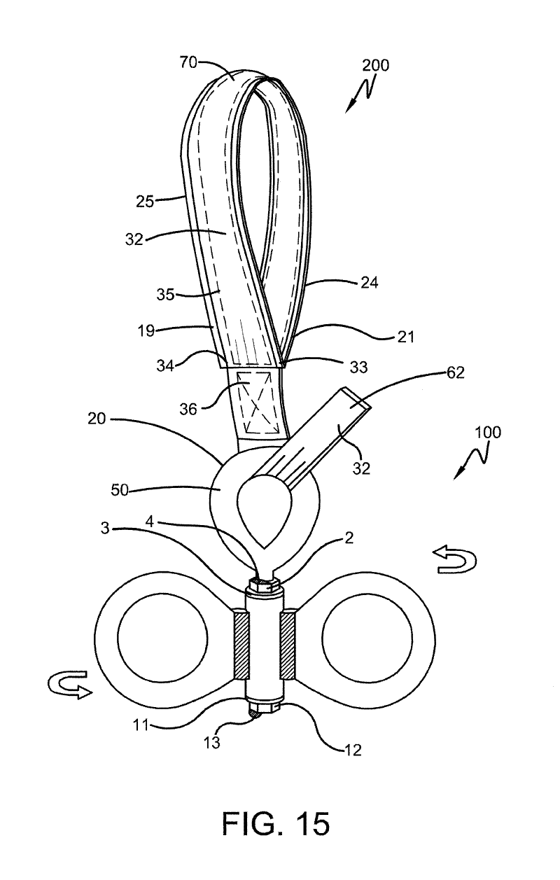

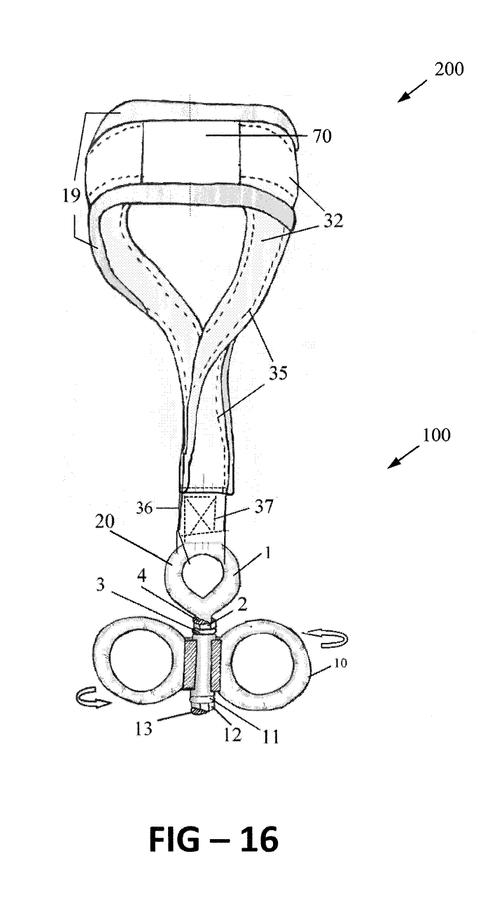

With reference to FIGS. 7-15, a method of forming a handle assembly 200 will be described, according to one embodiment. A resilient pad 21 is placed on a fabric 19, as shown in FIGS. 7 and 8. Then, one side of the fabric 19 is folded over the pad 21 at fold 24, and then the other side 25 of the fabric 19 is folded over the pad 21 at fold 25, as shown in FIGS. 9 and 10. Next, the top and bottom of the fabric 19 are folded inward forming a top center point 30 with top right and left corner folds 26, 27 and a bottom center point 31 with bottom right and left corner folds 28, 29, as shown in FIG. 11. Then the top and bottom center points 30, 31 can be folded inward forming a cuboid or rectangular cuboid, as shown in FIG. 12. Next, the strap 32 can be positioned and attached to the padding assembly 60, as shown in FIGS. 13 and 14. Then, the strap 32 can be folded over forming a loop and attached to itself at reference 36 so that the reference marks 33 and 34 converge or meet, as shown in FIG. 15. The handle assembly 200 can then be attached to the leash assembly 100 by placing the end 62 of the strap 32 through the ring 50 and attaching the end 62 to reference 37, which can overlap reference 36. The attached handle assembly 200 is shown in FIGS. 15 and 16, according to some embodiments. The preceding description is just one non-limiting example of forming a handle assembly 200. Many other devices, apparatus, mechanisms, and methods can be used to form a handle assembly 200, which are within the scope of this invention.

With reference to FIGS. 1, 6, 13, 14, 15, and 16, a logo 70 can be attached to the handle 14 or the handle assembly 200, according to some embodiments. The logo 70 can be positioned anywhere on the handle 14 or handle assembly 200. In some embodiments, the logo 70 can be positioned at the location where a user would grasp the handle 14 or handle assembly 200 during use. In other embodiments, the logo is centered at or near the top of the handle 14 or handle assembly 200.

In one embodiment, the leash assembly 100 can include the listed elements or components according to the following non-limiting example: ⅜″-16×4″ eye bolt 1; ⅜″-16 national course hex nut 2; ⅜″ flat washer 3; tack weld or securement 4; an approximately 1½″ welded ring 5; an approximately 1½″ welded ring 6; an approximately 1¼″ long ⅜″ schedule 80 unthreaded pipe nipple 7; seam weld 8; seam weld 9; ⅜″ flat washer 11; ⅜″-16 national course hex nut 12; tack weld or securement 13; an approximately 1″×22″× 3/16″ nylon or leather strapping 14; machine sewn “square” and “x” pattern 15; machine sewn “square” and “x” pattern 16; leash 17; and leash 18. The preceding description is just one non-limiting example of the leash assembly 100.

In one embodiment, the leash assembly 100 can be assembled according to the following non-limiting example. Screw one ⅜″-16 national course hex nut 2 onto a ⅜″×4″ eye bolt 1. Tack weld or otherwise secure 4 one ⅜″-16 national course hex nut 2 to the ⅜″×4″ eye bolt 1. Slide one ⅜″ standard flat washer 3 onto the ⅜″×4″ eye bolt 1 below the welded or secured ⅜″-16 national course hex nut 2. Slide the swivel member 10 onto the ⅜″×4″ eye bolt 1. Slide a ⅜″ standard flat washer 11 onto the ⅜″×4″ eye bolt 1 below the swivel member 10. Screw a ⅜″-16 national course hex nut 12 onto the ⅜″×4″ eye bolt 1. Tack weld or otherwise secure 13 the bottom of the national course hex nut 12 to the ⅜″×4″ eye bolt 1 leaving enough play in the swivel member 10 to rotate freely. Take one end of an approximately 1″×22″× 3/16″ nylon or leather strapping 14 and thread it through the eye on the ⅜″×4″ eye bolt 1 approximately 2″ and fold the strapping 14 over. Using a sewing machine, sew the short end of the approximately 1″×22″× 3/16″ nylon or leather strapping 14 to the long end of the strap by making an approximately 1″ square pattern and then an X pattern inside the newly sewn square pattern at reference 15. Take the opposite end of the approximately 1″×22″× 3/16″ nylon or leather strapping 14 and fold it over meeting the first end. Using a sewing machine, sew an approximately 1″ square pattern, and then an X pattern inside the newly sewn square pattern at reference 16 to create a secure handle with an approximately 7″ opening. This creates an approximately 10″ long handle 14 with an approximately 7″ opening for a user's hand. Use any two leashes 17, 18 and loop the handle of the leashes 17, 18 through each approximately 1½″ welded metal rings 5, 6 on the swivel member 10 and pull tight. Attach the ends of the leashes 17, 18 to any two pets including, but not limited to, any small, medium, or large breed dogs. The preceding description is just one non-limiting example of assembling the leash assembly 100.

In one embodiment, the handle assembly 200 can include the listed elements or components according to the following non-limiting example: approximately 4″×17″ rip stop nylon fabric 19; approximately 4-5 mm thick×1½″×15″ foam padding 21; approximately 1″ top fold 22 in fabric 19; approximately 1″ bottom fold 23 in fabric 19; right fold 24 in fabric 19; left fold 25 in fabric 19; top right corner fold 26 in fabric 19; top left corner fold 27 in fabric 19; bottom right corner fold 28 in fabric 19; bottom left corner fold 29 in fabric 19; top center point 30 of fabric 19; bottom center point 31 of fabric 19; approximately 1′×23″ nylon or leather strapping 32; approximately 1½″ top measure mark 33 of strapping 32; approximately 7″ bottom measure mark 34 on strapping 32; machine sewn “square” and “x” pattern 36 on strapping 32; machine sewn “square” and “x” pattern 37 on strapping 32. The preceding description is just one non-limiting example of the handle assembly 200.

In one embodiment, the handle assembly 200 can be assembled according to the following non-limiting example. Measure top fold line 22 approximately one inch in from the approximately 4″ edge of fabric 19; measure the bottom fold line 23 approximately one inch in from the opposite approximately 4″ edge of fabric 19; fold the top right corner 26 and the top left corner 27 to form the top center point 30 of the fabric 19; fold the bottom right corner 28 and the bottom left corner 29 to form the bottom center point 31 of fabric 19; fold the top center point 30 down at top fold line 22; fold the bottom center point 31 up at bottom fold line 23; measure approximately 1½″ on one end of strapping 32 for top mark 33, and measure approximately 7″ on the opposite end of strapping 32 for bottom mark 34; sew a rectangle 35 attaching strapping 32 to fabric 19 containing foam padding 21; fold strapping 32 over joining reference 33 and reference 34 where the edges of the fabric 19 converge and sew a “square” and “x” pattern 36; feed the approximately 7″ end 62 of strapping 32 through the ring 52 on the leash assembly 100 overlapping reference 36 and sew a “square” and “x” pattern 37; loop leashes 17 and 18 through each ring 5, 6 in the swivel member and pull the leashes 17, 18 tight. Attach the other end of leashes 17 and 18 to two collared or harnessed pets, including, but not limited to, any small, medium, or large breed dogs. The preceding description is just one non-limiting example of forming the handle assembly 200.

According to some embodiments, the leash assembly 100 is designed for large breed dogs. According to other embodiments, the leash assembly 100 can be used with either collared or harnessed dogs. According to other embodiments, the leash assembly 100 is strong enough for harnessed weight pulling dogs, and can be used for rescue or service dogs that need to be tethered.

According to some embodiments, the leash assembly 100 is used with two dogs. According to other embodiments, the leash assembly 100 is designed to accommodate two large breed dogs tethered together. According to other embodiments, when dogs of different sizes are tethered together, adjustment in length of leashes 17, 18 may be used in order to make it more comfortable for the dogs. According to other embodiments, the leash assembly 100 can include almost any length of leashes 17, 18 and the two leashes 17, 18 can be different lengths from each other. According to other embodiments, the leash assembly 100 can be made in various sizes.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A leash assembly for multiple pets comprising:
a base member including a shaft and a first ring;
a swivel member including a tube and second and third rings, the swivel member rotatably connected to the base member, wherein the shaft of the base member is at least partially located within the tube, and wherein the tube and second and third rings rotate about the shaft.

2. The leash assembly of claim 1, wherein the first ring is positioned at one end of the shaft.

3. The leash assembly of claim 1, wherein the first ring is fixedly positioned relative to the shaft.

4. The leash assembly of claim 1, wherein the first ring is fixedly attached to the shaft.

5. The leash assembly of claim 1, wherein the second and third rings are positioned on opposite sides of the tube.

6. The leash assembly of claim 1, wherein the second and third rings are fixedly positioned relative to the tube.

7. The leash assembly of claim 1, wherein the second and third rings are fixedly attached to the tube.

8. The leash assembly of claim 1, wherein the base member further comprises a base plate and a bushing positioned between the base plate and the tube of the swivel member.

9. The leash assembly of claim 1, further comprising:
a strap operatively attached to the base member; and
first and second leashes operatively attached to the swivel member.

10. The leash assembly of claim 1, further comprising:
a handle assembly including a padding assembly and a strap, wherein the handle assembly is operatively attached to the first ring of the base member;
a first leash operatively attached to the second ring of the swivel member; and
a second leash operatively attached to the third ring of the swivel member.

11. The leash assembly of claim 1, wherein the shaft of the base member extends through the tube and a fastening device attaches to the shaft rotatably connecting the swivel member to the base member, and wherein a bushing is positioned between the swivel member and the fastening device.

12. A leash assembly for multiple pets comprising:
a base member including a shaft, a first ring, a base plate, and a bushing, wherein the first ring is fixedly positioned relative to the shaft;
a swivel member including a tube and second and third rings, wherein the second and third rings are fixedly positioned relative to the tube, wherein the swivel member is rotatably connected to the base member, and the shaft of the base member is at least partially located within the tube with the bushing positioned between the base plate and the tube, and wherein the tube and second and third rings rotate about the shaft;
a handle assembly including a padding assembly and a strap, wherein the handle assembly is operatively attached to the first ring of the base member;
a first leash operatively attached to the second ring of the swivel member; and
a second leash operatively attached to the third ring of the swivel member.

13. A method comprising the steps of:
attaching a first ring to a shaft in a fixed relation;
attaching second and third rings to a tube in a fixed relation;
mounting the tube onto the shaft in a rotational relation;
attaching a handle assembly to the first ring;
attaching a first leash to the second ring; and
attaching a second leash to the third ring.

14. The method of claim 13, wherein prior to the step of mounting the tube, the method further comprises the steps of:
positioning a bushing on the shaft.

15. The method of claim 13, further comprising the steps of:
positioning a bushing on the shaft after mounting the tube onto the shaft; and
attaching a fastening device to an end of the shaft maintaining the tube on the shaft in a rotational relation.

16. The method of claim 13, wherein prior to attaching a handle assembly, the method further comprises the steps of:
enclosing a resilient pad within a fabric;
attaching the fabric to a strap to form a handle assembly.

17. The method of claim 16, wherein the step of enclosing a resilient pad further comprises the steps of:
placing the resilient pad on the fabric;
folding a first edge of the fabric over the resilient pad;
folding a second edge of the fabric over the resilient pad;
forming a triangle at the top and bottom edges of the fabric;
folding the triangles inwardly substantially encapsulating the resilient pad with the fabric.
